(19) United States
(12) Patent Application Publication
(10) Pub. No.: US 2025/0390845 A1
(43) Pub. Date: Dec. 25, 2025

(54) HEALTH INDEX OF A ROTATING ASSET

(71) Applicant: Honeywell International Inc., Charlotte, NC (US)

(72) Inventors: Karthik Prabodh Upadhya, Dublin (IE); Mandar Bandodekar, Dublin (IE); Jasmin Shah, Dublin (IE)

(21) Appl. No.: 18/752,788

(22) Filed: Jun. 25, 2024

(51) Int. Cl. G06Q 10/20

(52) U.S. Cl. CPC G06Q 10/20

(57) ABSTRACT

Techniques for determining an overall health status of a rotating asset are described. In one aspect, a type of the rotating asset is identified and one or more operational parameters corresponding to the rotating asset are obtained for a first time period. The one or more operational parameters are monitored over the first time period to detect an anomaly, and a deviation of the first operational parameter value from the first operating range is calculated to compute an anomaly score associated with the anomaly detected. In correspondence to the anomaly score and the one or more operational parameters, one or more degradation indicators for the rotating asset are derived, from which, a Unified Degradation Indicator (UDI) is determined. Further, an overall health report in correspondence to the UDI is generated, and accordingly, one or more maintenance actions associated with the rotating asset is initiated.

### TECHNICAL FIELD

The present subject matter relates, in general, to industrial asset health monitoring, and in particular, to determining an overall health status a rotating asset operating in a facility.

### BACKGROUND

Operation and maintenance of industrial assets are pivotal to the productivity and efficiency of various sectors, including manufacturing, energy, transportation, distribution centers, and the like. Industrial assets, such as rotating machinery, are subject to wear and tear, environmental conditions, and operational stresses that can degrade their performance over time. To mitigate the risks associated with asset failure, industries have traditionally relied on scheduled preventive maintenance strategies. These strategies are designed to service assets before they reach a failure point, thereby avoiding unexpected downtimes and the associated prohibitive costs.

### SUMMARY

Aspects of the present subject matter provide techniques for determining an overall health status of a rotating asset operating in a facility.

According to an example of the present subject matter, a method to determine an overall health status of a rotating asset operating in a facility is provided. The method includes identifying a type of the rotating asset and obtaining one or more operational parameters corresponding to the rotating asset for a first time period. The one or more operational parameters are obtained from one or more sensing elements coupled to the rotating asset. The one or more operational parameters are monitored over the first time period to determine at least a first operational parameter value from amongst the one or more operational parameters to be beyond a first operating range to detect an anomaly. The anomaly indicates a deviation of the first operational parameter value from the first operating range. Further, the deviation of the first operational parameter value from the first operating range is calculated to compute an anomaly score associated with the anomaly detected. One or more degradation indicators are derived for the rotating asset in correspondence to the anomaly score and the one or more operational parameters, where each degradation indicator from the one or more degradation indicators is indicative of an aspect of an overall health status of the rotating asset. From the one or more degradation indicators, a Unified Degradation Indicator (UDI) is determined, where the UDI corresponds to a current measure of the overall health status of the rotating asset. In correspondence to the UDI determined for the rotating asset, an overall health report is generated. Furthermore, one or more maintenance actions associated with the rotating asset in correspondence to the overall health report of the rotating asset is initiated.

According to another example of the present subject matter, a system for determining an overall health status of a rotating asset operating in a facility is provided. The system includes an assessment module and a UDI module. The assessment module is to identify a type of the rotating asset and obtain one or more operational parameters corresponding to the rotating asset for a first time period, where the one or more operational parameters are obtained from one or more sensing elements coupled to the rotating asset. The UDI module is to monitor the one or more operational parameters over the first time period to determine at least a first operational parameter value from amongst the one or more operational parameters to be beyond a first operating range to detect an anomaly, where the anomaly indicates a deviation of the first operational parameter value from the first operating range. Further, the UDI module is to calculate the deviation of the first operational parameter value from the first operating range to compute an anomaly score associated with the anomaly detected, derive one or more degradation indicators for the rotating asset in correspondence to the anomaly score and the one or more operational parameters, where each degradation indicator from the one or more degradation indicators is indicative of an aspect of an overall health status of the rotating asset. On deriving one or more degradation indicators, the UDI module is to determine a Unified Degradation Indicator (UDI) from one or more degradation indicators, where the UDI corresponds to a current measure of the overall health status of the rotating asset, generate an overall health report in correspondence to the UDI for the rotating asset, and initiate one or more maintenance actions associated with the rotating asset in correspondence to the overall health report of the rotating asset.

According to another example of the present subject matter, a non-transitory computer readable medium containing program instruction is provided, that, when executed, causes the processor to identify a type of the rotating asset and obtain one or more operational parameters corresponding to the rotating asset for a first time period, where the one or more operational parameters are obtained from one or more sensing elements coupled to the rotating asset, monitor the one or more operational parameters over the first time period to determine at least a first operational parameter value from amongst the one or more operational parameters to be beyond a first operating range to detect an anomaly, where the anomaly indicates a deviation of the first operational parameter value from the first operating range; calculate the deviation of the first operational parameter value from the first operating range to compute an anomaly score associated with the anomaly detected, derive one or more degradation indicators for the rotating asset in correspondence to the anomaly score and the one or more operational parameters, where each degradation indicator from the one or more degradation indicators is indicative of an aspect of an overall health status of the rotating asset, determine a Unified Degradation Indicator (UDI) from the one or more degradation indicators, where the UDI corresponds to a current measure of the overall health status of the rotating asset, generate an overall health report in correspondence to the UDI for the rotating asset, and initiate one or more maintenance actions associated with the rotating asset in correspondence to the overall health report of the rotating asset.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a supply chain network environment, in accordance with an example implementation of the present subject matter.

FIG. 2 illustrates an example supply chain network environment, in accordance with an example implementation of the present subject matter.

FIG. 3 illustrates an asset monitoring system, in accordance with an example implementation of the present subject matter.

FIG. 4 illustrates an example representation of a Unified Degradation Indicator, in accordance with an example implementation of the present subject matter.

FIG. 5 illustrates an example of determining the Remaining Useful Life of a rotating asset, in accordance with an example implementation of the present subject matter.

FIG. 6 illustrates an example of determining a unified degradation indicator for a rotating asset operating in a facility, in accordance with an example implementation of the present subject matter.

FIG. 7 illustrates a method for determining an overall health status of a rotating asset, in accordance with an example implementation of the present subject matter.

FIG. 8 illustrates a method for determining remaining useful life of the rotating asset, in accordance with an example implementation of the present subject matter.

FIG. 9 illustrates another example for determining an overall health status of a rotating asset operating in a facility, in accordance with an example implementation of the present subject matter.

FIG. 10 illustrates a non-transitory computer-readable medium for determining an overall health status of a rotating asset, in accordance with an example implementation of the present subject matter.

### DETAILED DESCRIPTION

The present subject matter relates to techniques for determining an overall health status of a rotating asset operating in a facility, and accurately predicting the Remaining Useful Life (RUL) of such assets. Effective monitoring and maintaining of assets in a facility, such as an industrial facility, is performed to ensure that all the assets of the facility, and in turn, the industrial facility works in an efficient manner. In industrial settings, the performance and reliability of rotating machinery, such as motors, gas turbines, centrifugal pumps, and the like, are integral to the operational efficiency. Generally, from installation to disposal, such assets of the facility are subjected to multiple changes owing to different environmental and physical factors, such as temperature fluctuations, mechanical stress, and abrasive conditions, throughout their life cycle. Such factors lead to wear and tear, corrosion, or other forms of degradation, which would ultimately alter the performance of the asset. Consequently, assessing the health of an asset to predict the behavior of the asset over a prolonged period of time, for instance, to predict the RUL of the asset becomes important, where RUL of an asset is a metric that estimates the duration for which an asset can continue to perform its intended function before requiring repair or replacement.

Assessing the health of the asset and predicting the RUL are not merely beneficial for optimizing maintenance schedules and preempting unplanned maintenance, but also play a pivotal role in managing inventory for spare parts, planning capital expenditures for asset replacement or repair before the onset of failure, ensuring the reliability and availability of the asset for production processes. Considering an example of an industrial compressor used in a manufacturing plant, over time, the compressor's components may degrade due to continuous operation under high pressure, leading to a gradual loss of efficiency and an increased risk of unexpected failure. Proactive health assessment of such an asset allows for timely maintenance interventions, such as replacing worn seals or bearings, which can extend the compressor's operational life and prevent expensive production stoppages.

Typically, traditional approaches of determining health of an asset rely on generating a health index for an asset based on past failure data of the said asset, or past failure data of similar assets of the same make or model. However, analysis of past failure data of the asset or past failure data of similar assets is based upon limited parameters which do not provide a comprehensive or accurate determination of the asset's health. Consequently, preventive maintenance schedules generated from such data often lead to a lack of complete lifetime data or run-to-failure data for these assets. In some known techniques, health of an asset may be calculated using various methodologies, including single condition indicators, failure threshold values, and dimensionality reduction techniques. However, the potential for inaccuracies due to the reliance on a single indicator can be high, and the complexity of interpreting and implementing results from dimensionality reduction techniques like Principal Component Analysis (PCA), especially in real-time operational settings, can be challenging. For instance, a fleet of identical pumps may exhibit different failure patterns based on their specific usage scenarios, maintenance history, and environmental conditions. Solely relying on historical data from similar assets may not accurately reflect an individual asset's condition. Also, a health index based on historical failure patterns may not account for the impact of recent changes in operational conditions or maintenance practices.

Further, in many situations, past failure data of the asset, or past failure data of similar assets is unavailable, particularly for newer assets or those with long service lives. This lack of data necessitates reliance on approximations or generic models that may not reflect the actual condition of the asset, leading to either premature or delayed maintenance actions. Moreover, for newly commissioned assets or those with infrequent failure events, sufficient historical data may not exist. In such scenarios, determining the health index and predicting the remaining useful life of the asset becomes challenging and has to be typically determined based on approximations.

According to examples of the present subject matter, techniques that provide comprehensive assessment of an asset's health and predict its RUL with an increased accuracy in real-time are provided. In operation, to determine an overall health status of a rotating asset operating in a facility, a type of the rotating asset is identified. For example, the rotating asset may be identified as an AC motor, which is a common type of rotating asset in industrial facilities. On identifying the type of the rotating asset, multiple operational parameters corresponding to the rotating asset are obtained for a first time period. These multiple operational parameters may be obtained from one or more sensing elements coupled to the rotating asset. For example, sensors attached to the AC motor may collect data on various operational parameters such as motor temperature, vibration levels, electrical current, and rotational speed over a specified time period.

Further, these multiple operational parameters may be monitored over the first time period, for example, for a duration of the preceding week, to determine at least a first operational parameter value from amongst the multiple operational parameters to be beyond a first operating range. For example, while monitoring the operational parameters such as temperature, vibration levels, electrical current, and rotational speed of the AC motor for the preceding week, it may be observed that the temperature levels of the AC motor are beyond a desired range of temperature levels for the said motor. These values, which are beyond the said range may be detected as an anomaly, where the anomaly indicates a deviation of the temperature values from the acceptable operating range. Once an anomaly is detected, a score is calculated to quantify the deviation from the first operating range. For example, if the normal operating temperature for the AC motor lies between 40 degrees to 45 degrees, a sensor reading of 45.2 degrees might be considered a small deviation from the desired range for the said AC motor, and the anomaly score associated with such a deviation would be low. However, if a sensor reading of 90 degrees is observed, which is outside the normal operating range, a higher anomaly score may be assigned to such a deviation.

In correspondence to the anomaly score that is computed and the one or more operational parameters, one or more degradation indicators may be derived. For example, the degradation indicators derived may include, but not limited to, a rolling cumulative anomaly count, a rate of change in cumulative anomaly count, rolling mean of anomaly score, rolling standard deviation of anomaly score, rolling kurtosis for vibration axes, and rolling number of starts, and the like. In one example, each degradation indicator may be indicative of an aspect of an overall health status of the rotating asset. For example, the degradation indicator such as the rolling number of starts, for an AC motor, may correspond to the number of times the motor starts and stops. Each start-stop cycle can impose mechanical and thermal stress on the motor's components, such as bearings, windings, and the rotor. Over time, frequent start-stop cycles can lead to accelerated wear and tear, reducing the motor's lifespan.

On deriving the multiple degradation indicators, a Unified Degradation Indicator (UDI) may be determined, where the UDI corresponds to a current measure of the overall health status of the rotating asset. That is, the UDI may be dynamically updated as new data is received corresponding to multiple degradation indicators, ensuring that the UDI reflects an accurate overall condition of the asset. For example, the UDI value may provide a quantifiable measure of the motor's health. A lower UDI value would indicate a healthier motor, while a higher UDI value suggests more severe degradation.

On determining the UDI, an overall health report in correspondence to the UDI for the rotating asset may be generated. For example, the overall health report may include one or more maintenance actions associated with the rotating asset, such as predicting when maintenance or replacement of the motor may be necessary, or when preemptive bearing lubrication needs to be performed, or when cooling system checks need to be performed, and the like, to address the identified anomalies. Based on the overall health report generated, the one or more maintenance actions identified is initiated.

Additionally, the present subject matter delineates techniques for estimating the Remaining Useful Life of industrial assets, where estimating the RUL factors in the asset's average lifespan, current age of the said asset, the UDI determined for the said asset, the rate of change of the UDI determined, an impact factor computed for the asset, and a vibration class of the asset. Predicating the RUL of the asset dynamically by adapting to the variations in the Unified Degradation Indicator and other relevant variables in real-time, ensures that the predictions remain current and actionable.

Therefore, techniques of the present subject matter facilitate accurate prediction of the overall health status and the remaining useful life of the asset. Since the UDI is determined dynamically, even in a scenario where there is paucity of historical data, the health index of the asset can be determined reliably at any stage of the asset's lifecycle. Additionally, determination of the UDI dynamically also facilitates accurate, real-time determination the remaining useful life of the asset, rather than relying on techniques which are confined to forecasting and curve fitting on polynomial equations. Further, techniques of the present subject matter preempt unplanned maintenance and avert unexpected downtimes, thereby enhancing the operational reliability and diminishing the costs that may be incurred.

The above and other features, aspects, and advantages of the subject matter will be explained with regard to the following description and accompanying figures. It should be noted that the description and figures merely illustrate the principles of the present subject matter along with examples described herein and should not be construed as a limitation to the present subject matter. It is thus understood that various arrangements may be devised that, although not explicitly described or shown herein, embody the principles of the present disclosure. Moreover, all statements herein reciting principles, aspects, and examples thereof, are intended to encompass equivalents thereof. Further, for the sake of simplicity, and without limitation, the same numbers are used throughout the drawings to reference like features and components.

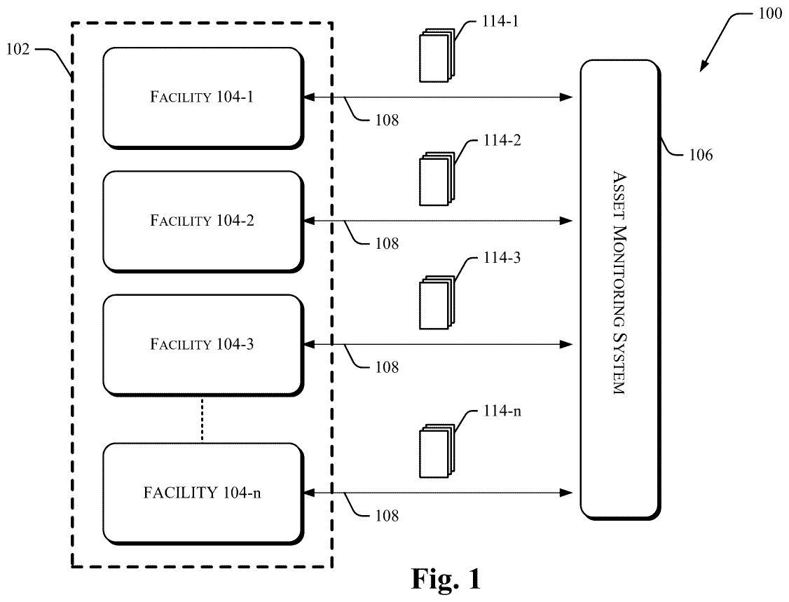

FIG. 1 illustrates a supply chain network environment 100, in accordance with an example implementation of the present subject matter. In one example, the supply chain network environment 100 may include a supply chain network 102 including multiple facilities, 104-1, 104-2, 104-3, . . . 104-n, collectively and alternatively referred to as multiple facilities 104 or facility 104. These facilities may span various industries where rotating electrical machines, such as AC motors, electrical generators, pumps, blowers, turbines, mixers, and the like, are pivotal for operations. For example, but not limited to, the facility 104 may be a warehouse in a packaging industry, an assembling unit of an automobile manufacturing company, a consumer-goods manufacturing unit, an e-commerce storage unit, a cold storage of a food manufacturing company, a pharmaceutical manufacturing unit, and the like. Although the following description has been explained with respect to rotating assets of a facility in a supply chain network, as would be understood to a person skilled in the art, similar principles would be applicable to rotating assets in power generation and transmission, and the like.

Each facility of the multiple facilities 104 may include a facility management system (not shown in the figure). In one example, the facility management system may be employed in each facility 104 for asset management. In one example, the facility management system may be part of a source device (not shown in the figure), where the source device may be an Internet of things (IoT) device, a computing device, a personal computer, a laptop, a tablet, a mobile phone, and the like. In another example, the facility management system may be hosted on a server (not shown in the figure) that may communicate with the source device.

In one example, the facility management system of each of the multiple facilities 104 may be communicatively coupled to an asset monitoring system 106. In another example, the facility management system of each of the multiple facilities 104 may function as the asset monitoring system 106. The facility management systems and the asset monitoring system 106 may communicate over a network 108. The network 108 may be a wireless network or a combination of a wired and wireless network. The network 108 can also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN). Depending on the terminology, the communication network includes various network entities, such as gateways and routers; however, such details have been omitted to maintain the brevity of the description.

Further, the asset monitoring system 106 may be implemented in any computing system, such as a storage array, a server, a desktop or a laptop, a computing device, a distributed computing system, or the like. Although not depicted, the asset monitoring system 106 may include other components, such as interfaces to communicate over the network or with external storage or computing devices, display, input/output interfaces, operating systems, applications, data, and other software or hardware components (not depicted for the sake of brevity).

In one example, the asset monitoring system 106 may obtain data 114-1, 114-2, 114-3, . . . , 114-n, collectively referred to as data 114, from multiple facilities 104-1, 104-2, 104-3, . . . 104-n, respectively. In one example, the data 114 generated by the multiple facilities 104, amongst other information, may include information relevant to the assets of each facility, such as number of assets, types of assets, asset IDs, sensor data, nameplate details, commissioning records of various assets, maintenance logs, and the like. For example, in a facility, such as a beverage packaging and assembling unit, the data 114 could indicate information pertaining to a variety of mixers, or data related to the operational machinery such as conveyor belts, assembling units, bottling machines, packaging systems, and general operating conditions associated with the machinery as well as their components. The data 114 may also include nameplate specifications of the machinery, ideal operational threshold values, sensor readings from the machinery, maintenance history of the assets, and records of assets that are either awaiting installation or that have been recently integrated into the beverage packaging and assembling unit's operational framework.

On obtaining data 114 from each of the facilities 104 within the supply chain network 102, the asset monitoring system 106, may analyze the data 114. In one example, the asset monitoring system 106 may analyze the data 114 to detect any anomaly that may be associated with the rotating asset. Based on the anomalies detected, one or more degradation indicators may be derived. On deriving the one or more degradation indicators, the asset monitoring system 106 may determine a Unified Degradation Indicator (UDI) for each rotating asset within a facility 104. In one example, the UDI may be a metric that represents a current and comprehensive assessment of the overall health status of the rotating asset, considering various degradation indicators that may be associated with the said asset. In one example, the asset monitoring system 106 may be adept at determining UDIs for a multitude of assets dispersed across the different facilities 104 within the supply chain network 102, thereby providing a holistic and detailed view of the health status of assets throughout the network. Subsequent to the UDI computation, the asset monitoring system 106 may generate an overall health status report for each assessed asset, which encapsulates the one or more actions that may need to be performed to for reliable functioning of the asset.

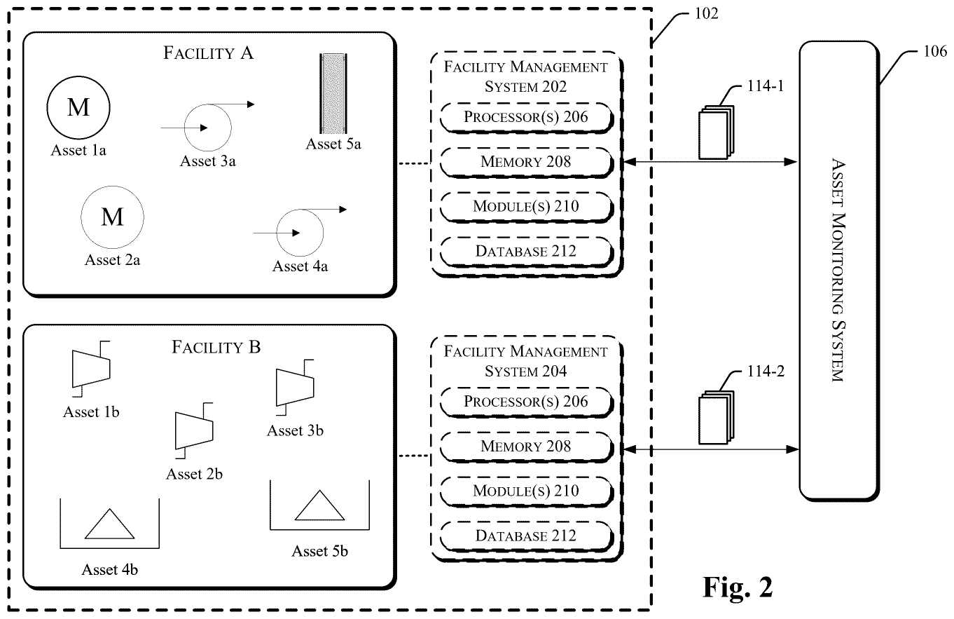

FIG. 2 illustrates an example supply chain network environment 102, in accordance with an example implementation of the present subject matter. In one example, the supply chain network 102 depicts two facilities, Facility A and Facility B. For the sake of simplicity, the following description has been predominantly discussed with reference to Facility A and Facility B of the supply chain network 102, communicatively coupled to the asset monitoring system 106. However, similar principles may be applicable to all facilities of a supply chain network 102 coupled to the asset monitoring system 106.

Facility A and Facility B may be equipped with multiple assets. Each facility may include diverse types of assets and may also be subject to different environmental conditions. For example, Facility A may be situated in an industrial environment, such as a steel manufacturing plant where assets are subjected to extreme conditions. On the other hand, Facility B may be a meticulously controlled environment, such as a pharmaceutical lab or a precision semiconductor manufacturing facility. As would be appreciated by a person skilled in the art, the data corresponding to an asset can vary not only based on the type of the asset but also the environment the asset is commissioned in, or the application for which the said asset is being utilized for. For example, the acceptable range of operation for an asset installed in Facility A may be very different for the same asset installed in Facility B, i.e., the acceptable operating ranges, for example, of a motor installed in the steel manufacturing facility, may be different from the acceptable operating ranges for a motor installed in the pharmaceutical lab.

In one example, Facility A of the supply chain network 102 may be located in a first geographical location and the Facility B of the supply chain network 102 may be located at a second geographical location. Each of the facilities, Facility A and Facility B, may include a facility management system 202, 204, respectively. The facility management systems 202, 204 may be employed to monitor the assets and the corresponding operation conditions of the said assets for Facility A and Facility B, respectively. In one example, the facility management system 202 of Facility A and the facility management system 204 of Facility B may be communicatively coupled to the asset monitoring system 106.

For the sake of simplicity, the following description has been discussed with reference to the facility management system 202 of Facility A, of the supply chain network 102. However, it may be understood that similar principles may be applicable to all other facilities 104 of the supply chain network 102. In one example, the facility management system 202 includes a processor 206 and a memory 208. The processor(s) may be provided through the use of dedicated hardware as well as hardware capable of executing instructions. When provided by a processor 206, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, standard and/or custom, may also be included. The memory 208 may include any computer-readable medium including, for example, volatile memory (e.g., RAM), and/or non-volatile memory (e.g., EPROM, flash memory, etc.).

The facility management system 202 may further include modules 210, such as data ingestion module (not shown in the figure). In one example, the data ingestion module may be implemented as a combination of hardware and firmware. In examples described herein, such combinations of hardware and firmware may be implemented in several different ways. For example, the firmware for the module may be processor executable instructions stored on a non-transitory machine-readable storage medium and the hardware for the module may include a processing resource (for example, implemented as either a single processor or a combination of multiple processors), to execute such instructions. In the present examples, the machine-readable storage medium may store instructions that, when executed by the processing resource, implement the functionalities of the modules. In such examples, the facility management system 202 may include the machine-readable storage medium storing the instructions and the processing resource to execute the instructions. In other examples of the present subject matter, the machine-readable storage medium may be located at a different location but accessible to the facility management system 202 and the processor(s) 206.

The facility management system 202 may further include a database 212, that serves, amongst other things, as a repository for storing data 114-1 that may be fetched, processed, received, or generated by the modules 210. The data 114-1 may include information associated with types of assets installed in the facility, asset IDs, operating conditions for each type of asset in the said facility, sensor readings from sensors installed on the assets of the facility, nameplate details, commissioning records of various assets, maintenance logs, assets that need to be relocated, assets that are yet to be installed, and the like.

In one example, the facility management system 202 of Facility A may obtain one or more operational parameters corresponding to each asset of Facility A. For example, Facility A may include high torque AC motors as a first type of asset represented as Asset 1a and Asset 2a, heavy-duty pumps as a second type of asset represented as Asset 3a and Asset 4a, and conveyor systems as a third type of asset represented as Asset 5a. Based on the type of asset, the one or more operational parameters from each of these assets, may be provided to the asset monitoring system 106. For example, for the first type of asset (Asset 1a and Asset 2a) operational parameters such as temperature values, vibration values, and acceleration values may be provided to the asset monitoring system 106. Similarly, for the second type of asset (Asset 3a and Asset 4a) operational parameters such as flow rate and pressure may be provided to the asset monitoring system 106. Furthermore, data 114-1 corresponding to installation details of the assets, assets that have been received at Facility A that need to be commissioned, maintenance logs of each of the assets, and the like, may be provided to the asset monitoring system 106. In one example, based on an asset ID, for example, the asset ID of Asset 1a, all data corresponding to Asset 1a may be accessible to the asset monitoring system 106. The asset monitoring system 106 may further analyze the data 114-1 corresponding to an asset, obtained from the facility management system 202, to determine the UDI for the said asset. In one example, a UDI value corresponding to each of the assets of Facility A, i.e., Asset 1a, Asset 2a, Asset 3a, Asset 4a, and Asset 5a may be generated, where the UDI may correspond the overall health status of the said asset. For example, the UDI value of Asset 1a may be 0.1, which would indicate that Asset 1a is in a healthy state, whereas the UDI value of Asset 2a may be 0.9 which would indicate that Asset 2a is degrading rapidly and needs to be replaced or repaired. In one example, based on the UDI values, an overall health report may be generated by the asset monitoring system 106, for Facility A, which includes data corresponding to each asset of the facility. In one example, the overall health report generated by the asset monitoring system 106 may be communicated to the facility management system 202.

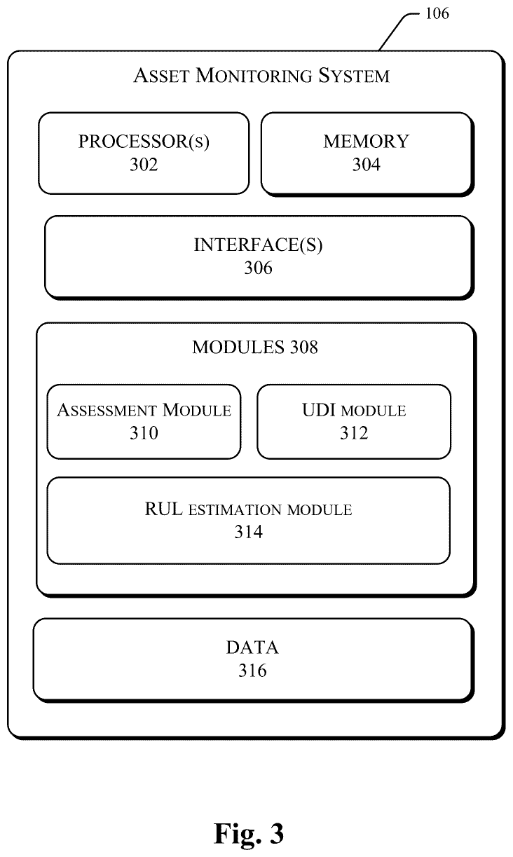

Similarly, the facility management system 204 of Facility B may obtain one or more operational parameters corresponding to each asset of Facility B. In one example, Facility B may include advanced HVAC systems, such as centrifugal pumps as a first type of asset represented as Asset 1b, Asset 2b, and Asset 3b, and high-powered centrifuges as a second type of asset represented as Asset 4b and Asset 5b. Based on the type of asset, the one or more operational parameters from each of these assets, may be provided to the asset monitoring system 106. For example, for the first type of asset (Asset 1b, Asset 2b, and Asset 3b) operational parameters such as temperature values, flow rates, and vibration values may be provided to the asset monitoring system 106. Similarly, for the second type of asset (Asset 4b and Asset 5b) operational parameters such as revolutions per minute and vibration may be provided to the asset monitoring system 106. Further, the facility management system 204 may provide various other data 114-2 associated with each of the assets as explained with refence to Facility A, to the asset monitoring system 106. The asset monitoring system 106 may further analyze the data corresponding to the assets of Facility B to determine the UDI, respectively. Accordingly, an overall health report may be generated, by the asset monitoring system 106, for Facility B with data corresponding to each asset of the facility and may be communicated to the facility management system 204. The determination of the UDI corresponding to each asset of the facility and generation of the overall health status report by the asset monitoring system 106 has been discussed with reference to FIG. 3.

FIG. 3 illustrates an asset monitoring system 106, in accordance with an example implementation of the present subject matter. In one example, the asset monitoring system 106, alternatively referred to as system 106, may facilitate accurate prediction of the overall health status of an asset operating in a facility. In one example, the asset monitoring system 106 may include a processor 302 and a memory 304 coupled to the processor 302. The functions of functional block labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, standard and/or custom, may also be included. Further, an interface(s) 306 may allow the connection or coupling of the system 106 with one or more other devices (say devices or systems within the supply chain network), through a wired (e.g., Local Area Network, i.e., LAN) connection or through a wireless connection (e.g., Bluetooth®, Wi-Fi). The interface(s) 306 may also enable intercommunication between different logical as well as hardware components of the system 106.

The memory 304 may include any computer-readable medium including, for example, volatile memory (e.g., RAM), and/or non-volatile memory (e.g., EPROM, flash memory, etc.).

The asset monitoring system 106 may further include modules 308, such as an assessment module 310, a UDI module 312, and a RUL estimation module 314. In one example, module(s) 308 may be implemented as a combination of hardware and firmware. In examples described herein, such combinations of hardware and firmware may be implemented in several different ways. For example, the firmware for the module may be processor executable instructions stored on a non-transitory machine-readable storage medium and the hardware for the module may include a processing resource (for example, implemented as either a single processor or a combination of multiple processors), to execute such instructions.

In the present examples, the machine-readable storage medium may store instructions that, when executed by the processing resource, implement the functionalities of the module(s) 308. In such examples, the asset monitoring system 106 may include the machine-readable storage medium storing the instructions and the processing resource to execute the instructions. In other examples of the present subject matter, the machine-readable storage medium may be located at a different location but accessible to the asset monitoring system 106 and the processor 302.

The asset monitoring system 106 may further include data 316, that serves, amongst other things, as a repository for storing data that may be fetched, processed, received, or generated by the modules 308. The data 316 may include asset data, operational parameter values, various threshold data values, vibration classification data, degradation indicator data, health status data, RUL data, maintenance logs, and the like. In an example, the data 316 may be stored in the memory 304.

Considering an example of a facility in the supply chain environment, the facility may have multiple assets such as pumps, motors, generators, blowers, compressors, conveyor belts, and the like. To determine a Unified Degradation Indicator for a rotating asset operating in the facility, in one example, the assessment module 310 of the asset monitoring system 106 may identify a type of the rotating asset and obtain one or more operational parameters corresponding to the rotating asset. In another example, the one or more operational parameters corresponding to the asset of the facility may be obtained from a facility management system of the concerned facility. For instance, if the type of rotating asset is identified to be an AC motor, operational parameters corresponding to an AC motor, such as acceleration, vibration, temperature, and the like, may be obtained. In another example, if the rotating asset is identified to be a HVAC pump, operational parameters corresponding to the HVAC pump, such as flow rate, pressure, temperature, and the like may be obtained. In one example, the one or more operational parameters of the rotating asset may be obtained from one or more sensing elements, such as sensors, coupled to the rotating assets. For example, for an AC motor, sensors such as Vibration-Temperature-Bearing (VTB) sensors may be utilized to obtain the operational parameters.

Further, the one or more operational parameters for the rotating asset may be obtained for a first time period. The first time period may be a duration for which the one or more operational parameters corresponding to the asset are monitored to determine the UDI. For example, the first time period may be the preceding week, the preceding two weeks, the preceding month, or one month prior to the current day, and the like. In one example, the first time period may be set based on an assumption that the maintenance of the rotating asset is performed on a regular basis. Thus, if the rotating asset did show any sign of degradation, for example two years ago, which is much greater than the first time period of, for example, the preceding two months or the preceding two weeks, it is assumed that the signs of degradation which appeared two years ago would have been considered and addressed through the scheduled maintenance, and hence, would not have an impact on the current overall health status of the rotating asset.

Further, in one example, the first time period may be a rolling time window, where the rolling time window corresponds to a fixed duration of time that progresses with respect to time. In one example, the rolling time window may be set to a duration of one week, ten days, one month, and the like. The following example is to illustrate the rolling time window and is not to be construed as a limitation. For instance, an operator of a facility may wish to monitor the operational parameters associated with a specific pump of the facility on January 15th. If the rolling time window is set to a duration of 4 days, the operational parameters may be monitored over a 4-day duration. The 4-day duration could be from January 1st to January 4th, or from January 10th to January 14th, and the like. Similarly, if the operator monitors the said pump in the subsequent week, for example, on January 20th, the 4-day duration could be from January 15th to January 19th and the like.

In one example, the rolling time window may be varied dynamically in accordance with the type of asset being monitored. For example, to monitor the operational parameters of an AC motor, the rolling time window may be set to a duration of 5 days. Whereas, to monitor the operational parameters of a conveyor belt, the rolling time window may be set to a duration of one month, and the like. In another example, the rolling time window may be set based on a sensitivity of the rotating asset. For example, if the rotating asset is very sensitive and susceptible to change, then the a very short duration of time, such as a duration of 2 days may be set as the rolling time window for the corresponding asset. For example, the rolling time window for an asset which is on the onset of degradation can be set to 3 days, so that the asset may be monitored in real time and appropriate action can be taken. In yet another example, the first time period may be provided by a user, for example, an operator of the said facility.

On obtaining the one or more operational parameters, the UDI module 312 of the asset monitoring system 106 may monitor the one or more operational parameters to detect an anomaly. In one example, the one or more operational parameters may be monitored over the first time period, to determine at least a first operational parameter value from amongst the one or more operational parameters to be beyond a first operating range. In one example, the first operating range may be the acceptable operating range for a corresponding parameter of the said asset. For example, each operational parameter of the rotating asset may have an acceptable range of operation, or a desired range of operation to ensure that the rotating asset functions optimally for the desired period of time. Considering the example of an AC motor installed in a steel manufacturing facility, each of the one or more operational parameters, such as acceleration, temperature, and vibration may have an acceptable operating range, respectively. For instance, the first operating range of temperature may lie between 25 degrees to 32 degrees, and the first operating range for the vibration parameter may be 0.011-0.028 inches/second. On monitoring the temperature values and vibration values of the motor for the preceding week, in one example, it may be observed that while the vibration values of the AC motor are within the acceptable range of operation, while some of the temperature values obtained were above 32 degrees. Based on the temperature values that deviate from the first operating range, in this example, deviate from the range of 25 degrees to 32 degrees, the anomaly may be detected. In one example, the acceptable operating range may also be dependent on the environment in which the asset is commissioned. For example, the acceptable operating range of temperature for an asset installed in a facility subject to harsh conditions, such as in a steel manufacturing facility may be different from the acceptable operating range of temperature for the same type of asset installed in a sensitive cleanroom facility.

Further, the UDI module 312 may calculate the deviation of the first operational parameter value from the first operating range to compute an anomaly score associated with the anomaly detected. In one example, the anomaly score may quantify an extent of deviation of the first parameter value of the one or more parameter values from the first operating range. For instance, a higher anomaly score may signify a greater deviation of the first operational value form the first operating range. With respect to the example of AC motor discussed above, since the temperature value monitored for the preceding week was observed to be 32 degrees, in which the deviation of the temperature value is slightly above the operating range of 25 degrees to 30 degrees, an anomaly score of 0.1 may be assigned to the deviation. Conversely, if the anomaly of the temperature value observed was for example, 60 degrees, which is much higher than the acceptable operating range of 25 degrees to 30 degrees, such a deviation may be assigned a higher anomaly score of 0.8.

Further, based on the anomaly score and the one or more operational parameters, the UDI module 312 may derive one or more degradation indicators for the rotating asset. In one example, each degradation indicator of the one or more degradation indicators may be indicative of a particular aspect of the overall health status of the rotating asset. In one example, degradation indicators corresponding to the anomaly score may include indicators such as a rolling cumulative anomaly count, a rate of change in cumulative anomaly count, a rolling mean of anomaly score, a rolling standard deviation of anomaly score, and the like. In another example, degradation indicators corresponding to the one or more operational parameters may include a rolling kurtosis for vibration axes, rolling number of starts, and the like.

In one example, a first degradation indicator such as the rolling cumulative anomaly count may be derived by determining a number of anomalies accumulated over a specified timeframe. In one example, the number of anomalies detected for a rotating asset on a given day may be compared against the number of anomalies detected on the previous day, or accumulated over the past several days, to determine the cumulative number of anomalies. An increase in the rolling cumulative anomaly count may indicate a rise in the frequency of anomalies for an asset, which may signal an elevated risk of degradation. On considering an example of an HVAC pump, if an increase in the number of anomalies associated with a flow rate of an HVAC pump is observed on the present day, which surpasses the number of anomalies detected in the preceding two days, a potential decline in the health of the asset may be anticipated.

Similarly, a second degradation indicator such as the rate of change in cumulative anomaly count may be derived by tracking the variation in the number of anomalies over time, which may aid in assessing the degradation status of the rotating asset. An escalating rate of change in the number of anomalies may imply that the frequency of anomalies is on the rise, suggesting that the asset's condition is deteriorating. For example, if it is observed that the rate of change in cumulative anomaly count for a water pump increases from an average of 1 anomaly per week to 3 anomalies per week over a month, this would suggest that the pump's condition is deteriorating more quickly than usual.

Further, a third degradation indicator such as the rolling mean of anomaly score may be derived, where the rolling mean of anomaly score facilitates discarding the sporadic outliers that may be detected due to transient anomalies. In one example, a higher rolling mean over a period of time would suggest the rotating asset is degrading at a higher rate than normal. Considering the example of an electric generator, it may be observed that the rolling mean of anomaly scores over a 30-day period shifts from 0.5 to 1.5, on a scale where higher scores indicate greater deviation from normal operation, this would imply that the generator's performance is consistently deviating from the normal, which may be a precursor to degradation.

Furthermore, a fourth degradation indicator such as the rolling standard deviation of anomaly score may be derived. A high rolling standard deviation of anomaly score would indicate acceleration in the start of unhealthy behavior of an asset within a specified timeframe. A high standard deviation indicates a greater spread of anomaly scores, which could signal the onset of erratic behavior within a specific timeframe and potentially the emergence of a fault. For example, for an air compressor, a low rolling standard deviation of anomaly scores might suddenly spike, indicating that the variability of the compressor's performance has increased. This could be a sign that the compressor is starting to behave unpredictably, possibly due to wear or an impending fault.

Further, degradation indicators corresponding to the one or more operational parameters, such as rolling kurtosis for vibration axes, may be derived. In one example, a fifth degradation indicator such as the rolling kurtosis for vibration axes may be derived, where the rolling kurtosis for vibration axes is a statistical measure that reflects the presence of outliers and anomalies in vibration data. In one example, a sudden spike in kurtosis could suggest that the asset is experiencing abnormal vibrations, which may be symptomatic of severe wear or imbalance. For instance, a centrifuge that typically exhibits stable kurtosis values may suddenly show an increase in the kurtosis values, indicating potential issues. For example, if there are significant differences between the vibration values monitored, or if there is a small dip in the frequency of vibration values, a spike in kurtosis may be observed.

Further, a sixth degradation indicator such as rolling number of starts may be derived, where frequent starts and stops may indicate that the asset is subjected to more frequent thermal and mechanical stress, leading to faster degradation. In one example, the rolling number of starts may be derived over a specific rolling time window, such as a week or a month. Considering the example of an AC motor used in an industrial conveyor system, the motor may be designed to manage a specific number of start-stop cycles during its expected operational life. For the sake of simplicity, it may be assumed that the motor has an expected operational life of 30,000 start-stop cycles and that the motor operates under normal conditions with an average of 10 start-stop cycles per day. In one example, due to changes in the production process, the motor may now be started and stopped 20 times per day, which would result in an increase in the start-stop frequency from the normal operational rate of the motor of 10 cycles/day to a current operational rate of 20 cycles/day. This increase in start-stop frequency by 100% from the normal rate would indicate that the motor may experience twice the expected mechanical and thermal stress per month.

Each of the six degradation indicators derived for the rotating asset thus provide a snapshot of a specific aspect of the rotating asset's condition, contributing to a comprehensive assessment of its overall degradation. Although deriving of the one or more degradation indicators has been explained with reference to the six degradation indicators as explained above, similar principles of the present subject matter may be applicable to other degradation indicators that may be derived for the rotating asset.

In one example, on deriving multiple degradation indicators, a Unified Degradation Indicator (UDI) may be determined, where the UDI corresponds to a current measure of the overall health status of the rotating asset at any given point of time, based on which decisions related to asset maintenance, or asset repair, and the like, can be performed. In one example, the UDI may be determined dynamically in correspondence to a current operational parameter. For example, while monitoring the vibration parameters of an AC motor on the present day, on detecting an anomaly and deriving the one or more degradation indicators as discussed above, the UDI determined for the AC motor on the present day may be 0.6. However, this value may be dynamically updated for the subsequent day in correspondence to the operational parameters monitored on the subsequent day.

In one example, the UDI may be determined by assigning weights to each degradation indicator based on relative impact of each of the degradation indicator on the asset's health. In one example, the weights assigned to each degradation indicator may be static and pre-determined based on, for example, historical data. In another example, the weights assigned to each indicator may be dynamically adjusted over time through machine learning algorithms or artificial neural networks (ANNs). The weighted indicators may then be combined to produce the UDI score. In one example, the weights for each degradation indicator may be assigned a priority in correspondence to an application in which the rotating asset is being utilized. For example, each of the six degradation indicators may be assigned a priority value, based on which the weights for the corresponding indicators may be assigned. For instance, for the AC motor functioning in a steel manufacturing facility, the rolling kurtosis for vibration axes may be assigned the highest priority, followed by the rolling number of starts, rolling cumulative anomaly count, and the like. Thus, the rolling kurtosis for vibration axes may be assigned a higher weightage than the other degradation indicators.

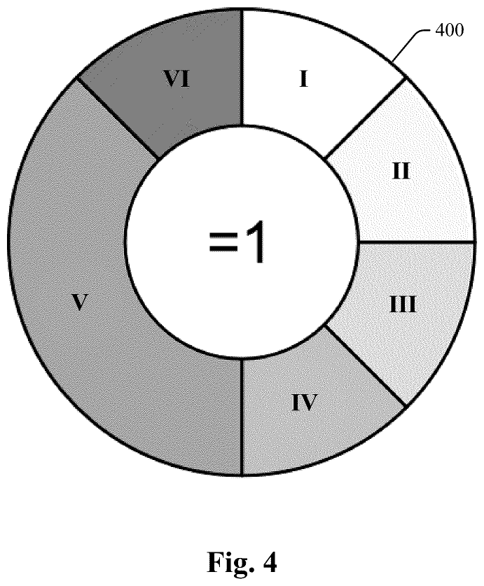

An example representation of the UDI 400 is depicted in FIG. 4, in accordance with the present subject matter. As may be observed from the figure, each of the six degradation indicators correspond to one specific aspect of the UD1 400. On considering the example of an AC motor as discussed above, a first portion ‘I’ of the chart depicting the UDI 400 may correspond to a first degradation indicator such as the rolling cumulative anomaly count. In one example, the rolling cumulative anomaly count of the motor may be derived to be 0.1. Similarly, a second portion ‘II’ of the chart depicting the UDI 400 may correspond to a second degradation indicator such as the rate of change in cumulative anomaly count. In one example, the rate of change in cumulative anomaly count of the motor may be derived to be 0.1. A third portion ‘III’ of the chart depicting the UDI 400 may correspond to a third degradation indicator such as the rolling mean of anomaly score. In one example, the rolling mean of anomaly score of the motor may be derived to be 0.1. A fourth portion ‘IV’ of the chart depicting the UDI 400 may correspond to a fourth degradation indicator such as the rolling standard deviation of anomaly score. In one example, the rolling standard deviation of anomaly score of the motor may be derived to be 0.1. A fifth portion ‘V’ of the chart depicting the UDI 400 may correspond to a fifth degradation indicator such as the rolling kurtosis of vibration axes. In one example, the rolling kurtosis of vibration axes of the motor may be derived to be 0.3. A sixth portion ‘VI’ of the chart depicting the UDI 400 may correspond to a sixth degradation indicator such as the rolling number of starts. In one example, the rolling number of starts of the motor may be derived to be 0.1. In this manner, the one or more degradation indicators derived may be scaled down such that the value of the UDI determined for a rotating asset may range between 0 and 1, 0 indicating that the rotating asset is in a healthy state and 1 indicating elevated levels of degradation. As illustrated in FIG. 4, each indicator depicts a value signifying an extent of degradation in correspondence to a specific aspect of the rotating asset's condition, which contributes to the rotating assets' overall degradation.

Continuing with the description of FIG. 3, on determining the UDI, an overall health report in correspondence to the UDI for the rotating asset may be generated. In one example, the overall health report may include one or more maintenance actions associated with the rotating asset. In one example, the overall health report may include details corresponding to the various assets of the facilities and may also indicate a UDI value corresponding to each asset. For example, the overall health report for Facility ‘A’ may include details regarding the UDI value corresponding to the HVAC pump and the UDI value corresponding to the AC motor of the facility, and the like. Additionally, the overall health status report may also indicate one or more maintenance actions associated with the rotating asset. For example, the one or more maintenance actions may indicate that the bearings of the AC motor need to be changed, or that the conveyor belt needs to be replaced, or that the gas turbines need to be repaired, and the like. Accordingly, the one or more maintenance actions associated with the rotating asset in correspondence to the overall health report of the rotating asset may be initiated.

In one example, a remaining useful life of the rotating asset may be determined in correspondence to the UDI, where the RUL may be determined based on the current degradation values to determine how soon the asset might breakdown without performing preventive maintenance, or by how much would the lifecycle of the asset be reduced due to the issues faced currently. In one example, to determine the RUL of the asset, the RUL model 214 of the asset monitoring system 106 may identify a class of the corresponding asset. In one example, the class of the asset may be identified in correspondence to the vibration parameters monitored with respect to the asset. Although the following example has been elucidated with reference to classifying the assets based on the vibration parameter, similar principles of the present subject matter may be applicable to classifying assets based on other operational parameters.

In one example, the rotating asset may be identified as belonging to any one of vibration class ‘A’, vibration class ‘B’, vibration class ‘C’, or vibration class ‘D’, where each vibration class corresponds to a set of pre-defined vibration threshold ranges, alternatively referred to as threshold ranges. For example, when the vibration parameters monitored for an asset lie within a first threshold range, the rotating asset may be classified into vibration class ‘A’, where vibration class ‘A’ may indicate that the rotating asset is a non-critical condition. Similarly, when the vibration parameters monitored for an asset lie within a second threshold range, the rotating asset may be classified into vibration class ‘B’, where vibration class ‘B’ may indicate that the rotating asset may be at the start of facing some abnormalities. Further, when the vibration parameters monitored for an asset lie within a third threshold range, the rotating asset may be classified into vibration class ‘C’, where vibration class ‘C’ may indicate that the rotating asset is at a disruptive state, and when the vibration parameters monitored for an asset lie within a fourth threshold range, the rotating asset may be classified into vibration class ‘D’, where vibration class ‘D’ may indicate that the rotating asset is in a very critical state which would require immediate maintenance or repair.

In one example, the first threshold value, the second threshold value, the third threshold value and the fourth threshold value may be static values based on International Organization for Standardization (ISO) standards for machinery. For example, for an AC motor, the first threshold range may lie between 0.011-0.028 inches per second, the second threshold range may lie between 0.044-0.071 inches per second, the third threshold range may lie between 0.11-0.28 inches per second, and the fourth threshold range may lie between 0.28-1.77 inches per second.

In one example, the RUL determination of the asset may be performed when the class of the said asset is identified to be any one of vibration class ‘B’, vibration class ‘C’, or vibration class ‘D’. For example, if the vibration parameter value for a rotating asset such as an AC motor is 0.020, which lies in the first threshold range of 0.011-0.028 inches per second, the AC motor would be classified as vibration class ‘A’ which would further indicate that no monitoring would be required. Conversely, if the vibration parameter value monitored for the AC motor is 0.89, which lies in the fourth threshold range of 0.28-1.77 inches per second, the AC motor would be classified as vibration class ‘D’ which would indicate that the AC motor is completely degraded and could breakdown anytime.

In another example, the vibration class may be dynamically determined, where the RUL estimation module of the asset monitoring system 106 may predict a vibration class of the asset. In one example, the vibration class may be predicted based on past UDI, current UDI, vibration, temperature, operating hours and the like. In one example, the RUL model may utilize Recurrent Neural Networks (RNN) that may be capable of learning and remembering information over time, for dynamic classification of the said asset.

Based on the vibration class of the asset, the UDI values of the corresponding asset may be monitored for a second period of time. The second period of time may correspond to a duration for which the UDI values of the asset are to be monitored, and further aggregated to determine the RUL corresponding to the said asset. In one example, the second period of time may be dependent on the vibration class of the asset, where the second period of time may be inversely proportional to the vibration class identified for the rotating asset, i.e., higher the vibration class, lower will be the second time period. For example, if the asset belongs to vibration class ‘A’, the monitoring of the UDI values may not be required. However, if the asset belongs to vibration class ‘C’ or ‘D’ the second time period may be set to a duration of the preceding two days, or preceding one week, and the like.

Further, in one example, the RUL model 214 of the asset monitoring system 106 may determine the remaining useful life of the rotating asset in correspondence to at least one of the UDI, an average life span of the rotating asset, a current age of the rotating asset, an impact factor, and the vibration class of the rotating asset.

In one example, the impact factor of the rotating asset may be determined in correspondence to at least one of an aggregated value of the UDI and a rate of change in the UDI. In one example, the aggregated UDI and the rate of change in the UDI may be computed for the second period of time.

In one example, the impact factor may be computed as represented in equation (1):

Impact Factor=1−Aggregated UDI*(1+x*(dy/dt)) (1)

### Where,

x represents an impact variable,
Aggregated UDI represents a mean value of the UDI computed over the
second time period, and
dy/dt represents a rate of change of the aggregated UDI.

In one example, the value of the impact variable ‘x’ may be pre-determined based on the vibration class of the asset, for example, when the rotating asset is classified based on static classes that have fixed threshold ranges, the value of the impact variable may be set to 1 for assets classified as vibration class C and vibration class D. In another example, the value of the impact variable may be set to 0 for assets classified as vibration class A and vibration class B, and the like. In another example, the impact variable may be dynamically determined.

Further, on determining the impact factor as represented in equation (1), the remaining useful life of the asset may be computed as represented below in equation (2):

RUL=(Average Lifespan−Current Age)*(Impact Factor) (2)

### Where,

Average lifespan represents the average lifespan of the rotating asset;
Current age represents the number of years the said asset in is operation from the first start of the asset, and

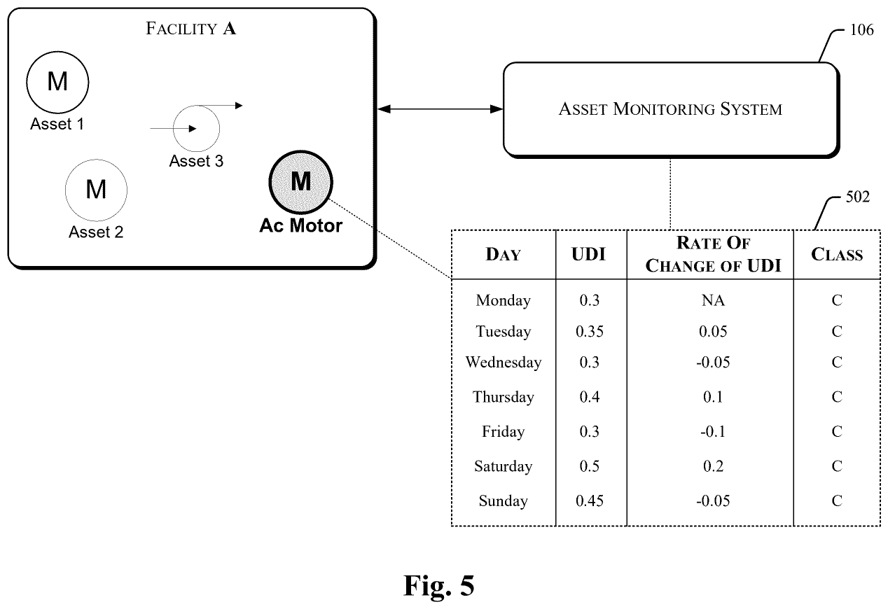

The following example is only to illustrate principles of the present subject matter and is not to be construed as a limitation. In one example, FIG. 5 illustrates an example of determining the Remaining Useful Life of a rotating asset, in accordance with an example implementation of the present subject matter. On considering the example of an AC motor installed in Facility ‘A’, as depicted in FIG. 5, the remaining useful life of the AC motor may be determined as follows, which may be dynamically updated on each day of the week in correspondence to the UDI value that is dynamically updated. In one example, the average lifespan of the motor may be considered to be 15 years, the current age of the motor may be considered to be 10 years, and the motor may be classified as vibration class ‘C’ motor. Further, the aggregated UDI values and a rate of change in the UDI values between the preceding day and the present day may be considered as depicted in Table 502, illustrated in FIG. 5. Based on equations (1) and (2) to determine the impact factor and the RUL of the asset as discussed above, the RUL on Tuesday may be computed as follows:

RUL on Tuesday=(15−10)*(1−0.35*(1+1*(1+0.05)))=3.16 years.

In one example, the RUL value computed for Tuesday of approximately 3.16 years suggests that, given the current health status, degradation rate, and impact of the anomalies, the AC motor is expected to operate effectively for over three more years before a potential failure or the need for a major overhaul may occur. Similarly, the RUL for other days of the week may be computed as follows:

RUL on Wednesday=(15−10)*(1−0.3*(1+1*(1−0.05)))=3.575 years,

RUL on Thursday=(15-10)*(1−0.4*(1+1*(1+0.1)))=2.8 years,

RUL on Friday=(15−10)*(1−0.3*(1+1*(1−0.1)))=3.65 years,

RUL on Saturday=(15−10)*(1−0.5*(1+1*(1+0.2)))=2 years, and

RUL on Sunday=(15−10)*(1−0.45*(1+1*(1−0.05)))=3.33 years.

Thus, by estimating the RUL of the asset in correspondence to an aggregated value of the UDI, which is determined dynamically for a rotating asset, the RUL can be calculated accurately.

Therefore, techniques of the present subject matter facilitate accurate prediction of the overall health status and the remaining useful life of the asset. Since the UDI is determined dynamically, even in a scenario where there is insufficient historical data, the health index of the asset can be determined reliably at any stage of the lifecycle of the asset. Additionally, determination of the UDI dynamically also facilitates accurate determination the remaining useful life of the asset in real-time, rather than relying on techniques which are limited to forecasting and curve fitting on polynomial equations to determine the RUL. Further, unplanned maintenance and downtimes can be avoided, thereby minimizing the costs that may be incurred.

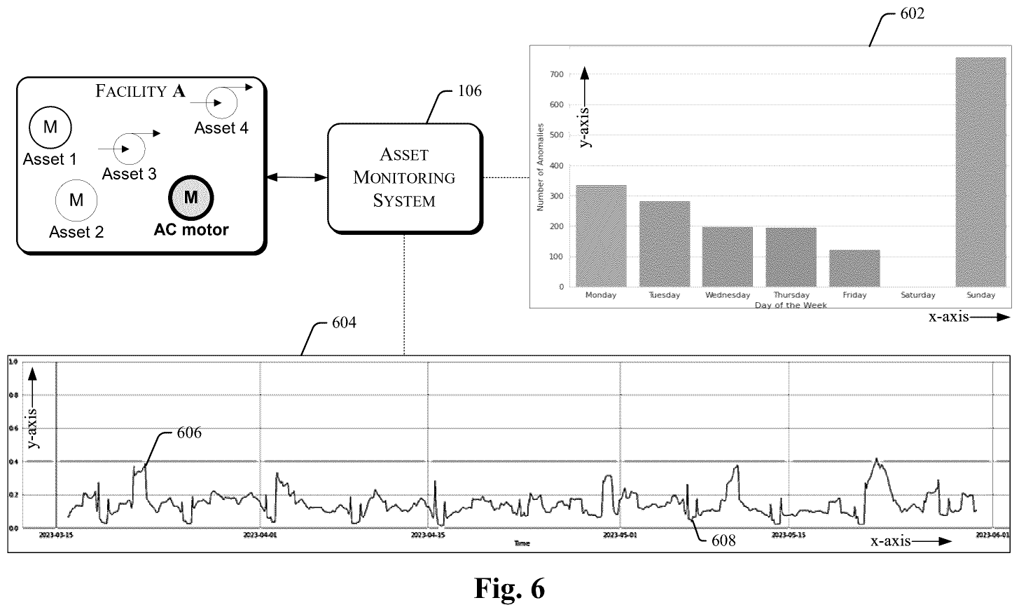

FIG. 6 illustrates an example of determining a unified degradation indicator for a rotating asset operating in a facility, in accordance with an example implementation of the present subject matter. The following example is only to illustrate principles of the present subject matter and is not to be construed as a limitation. For instance, Facility A could be a manufacturing plant with a variety of assets. A facility manager within the supply chain network may wish to evaluate the health of an asset deployed in the manufacturing plant. To do so, the facility manager may refer to the overall health status report for the specific asset. In this scenario, the asset under consideration could be an AC motor that powers the main conveyor belt, which is central to product movement within the manufacturing plant. It is assumed for this example that the manufacturing plant operates six days a week, with a scheduled day off on Saturday.

Accordingly, to generate the overall health status of the AC motor, in one example, the asset monitoring system 106 may obtain one or more operational parameters such as motor current, winding temperature, vibration levels, and the start-stop frequency of the motor. These parameters are continuously monitored to identify any anomalies that may arise. Over a first time period, such as one week, a number of anomalies may be detected. An anomaly chart 602 represents the frequency and distribution of these anomalies across the days of the week, where the number of anomalies is plotted on the vertical axis, y-axis, against time on the horizontal axis, x-axis. Based on the anomalies detected, one or more degradation indicators are derived to determine the Unified Degradation Indicator for the AC motor. Based on the UDI values, the asset monitoring system may generate an overall health status report including one or more actions and may initiate the one or more maintenance actions associated with the AC motor in correspondence to the overall health report of the rotating asset. In one example, the overall health status report for the AC motor may include a detailed trend chart 604. The detailed trend chart 604 may for the AC motor may depict Unified Degradation Indicator (UDI) over a span of 2.5 months, where the UDI values are plotted on the vertical axis, y-axis, against time on the horizontal axis, x-axis, depicting the dynamic health profile of the AC motor determined over the span of 2.5 months. The peaks 606 depicted on the trend chart 604 signify instances where the UDI has reached elevated levels, signaling that the asset is experiencing higher stress or wear and is thus more susceptible to degradation. These peaks may correspond to operational anomalies that adversely affect the asset's performance. Conversely, the dips 608 in the trend chart 604 represent instances during which the AC motor is not in operation, for example, on Saturdays. Therefore, dynamic determination of the UDI in real-time facilitates the identification of potential periods of increased risk, such as a series of high UDI readings that could indicate an accelerating degradation process. Accordingly, proactive measures can be taken to address issues during periods indicated by high UDI values, while confidence can be maintained during periods of low UDI readings. The facility manager can, therefore, make informed decisions regarding considering inspecting the motor for potential issues, such as bearing wear or insulation degradation, scheduling proactive maintenance, allocating resources effectively, and ultimately ensuring the reliability and efficiency in operations of the manufacturing plant.

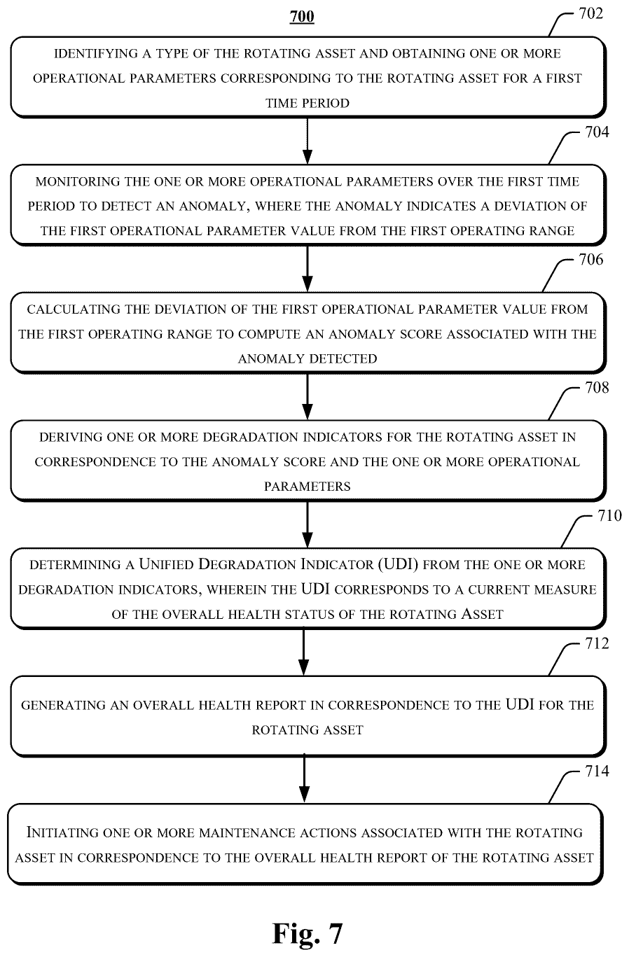

FIG. 7 illustrates a method 700 for determining an overall health status of a rotating asset operating in a facility, in accordance with an example implementation of the present subject matter. The order in which the method 700 is described is not intended to be construed as a limitation, and any number of the described method blocks can be combined in any order to implement method 700 or an alternative method. Additionally, individual blocks may be deleted from the method 700 without departing from the spirit and scope of the subject matter described herein. Furthermore, the method 700 may be implemented in any suitable hardware, computer readable instructions, firmware, or combination thereof. For discussion, the method 700 is described with reference to the implementations illustrated in FIGS. 1-6.

At block 702, the method 700 includes identifying a type of the rotating asset and obtaining one or more operational parameters corresponding to the rotating asset for a first time period. In one example, the one or more operational parameters include vibration, acceleration, and temperature. In one example, the one or more operational parameters are obtained from one or more sensing elements coupled to the rotating asset.

At block 704, the method 700 includes monitoring the one or more operational parameters over the first time period to detect an anomaly, where the anomaly indicates a deviation of the first operational parameter value from the first operating range. In one example, the one or more operational parameters are monitored over the first time period to determine at least a first operational parameter value from amongst the one or more operational parameters to be beyond a first operating range to detect the anomaly. In one example, the first time period may be a duration for which the one or more operational parameters corresponding to the asset are monitored to determine the UDI.

At block 706, the method includes calculating the deviation of the first operational parameter value from the first operating range to compute an anomaly score associated with the anomaly detected. In one example, the anomaly score may quantify an extent of deviation of the first parameter value of the one or more parameter values from the first operating range. For instance, a higher anomaly score may signify a greater deviation of the first operational value form the first operating range.

At block 708, the method 700 includes deriving one or more degradation indicators for the rotating asset in correspondence to the anomaly score and the one or more operational parameters, where each degradation indicator from the one or more degradation indicators is indicative of an aspect of an overall health status of the rotating asset. In one example, the one or more degradation indicators include rolling cumulative anomaly count, a rate of change in cumulative anomaly count, rolling mean of anomaly score, rolling standard deviation of anomaly score, rolling kurtosis for vibration axes, and rolling number of starts, and the like. In one example, the one or more degradation indicators are associated with a degradation value which corresponds to an extent of degradation of the corresponding one or more degradation indicator. Further, in one example, a priority may be assigned to the one or more degradation indicators in correspondence to an application in which the rotating asset is being utilized.

At block 710, the method 700 includes determining a Unified Degradation Indicator (UDI) from the one or more degradation indicators, wherein the UDI corresponds to a current measure of the overall health status of the rotating asset. In one example, the UDI is determined dynamically in correspondence to a current operational parameter value amongst the one or more operational parameters, where the value of the UDI is in a range of 0 to 1.

At block 712, the method 700 includes generating an overall health report in correspondence to the UDI for the rotating asset. In one example, in addition to the UDI values for an asset, the overall health status report may also indicate one or more maintenance actions associated with the rotating asset.

At block 714, the method 700 includes initiating one or more maintenance actions associated with the rotating asset in correspondence to the overall health report of the rotating asset.

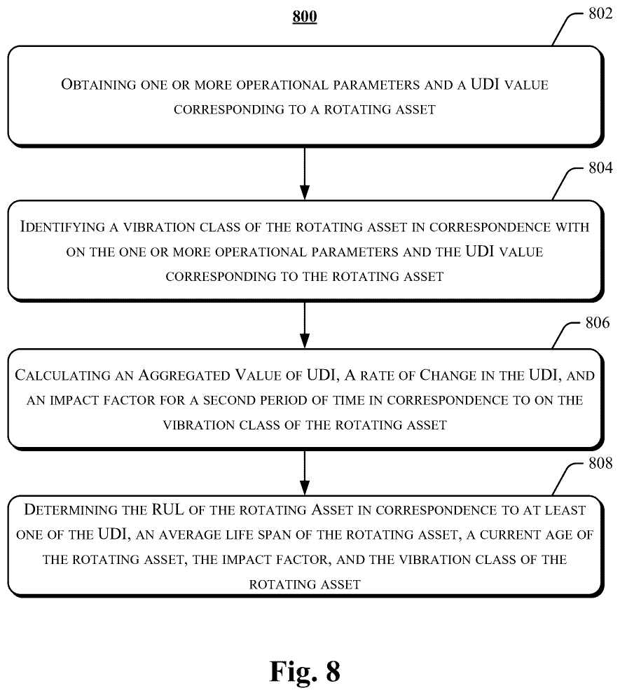

FIG. 8 illustrates a method 800 for determining the remaining useful life of the rotating asset, in accordance with an example implementation of the present subject matter. The order in which the method 800 is described is not intended to be construed as a limitation, and any number of the described method blocks can be combined in any order to implement method 800 or an alternative method. Additionally, individual blocks may be deleted from the method 800 without departing from the spirit and scope of the subject matter described herein. Furthermore, the method 800 may be implemented in any suitable hardware, computer readable instructions, firmware, or combination thereof. For discussion, the method 800 is described with reference to the implementations illustrated in FIGS. 1-6.

At block 802, the method 800 includes obtaining one or more operational parameters and a UDI value corresponding to a rotating asset.

At block 804, the method 800 includes identifying a vibration class of the rotating asset in correspondence with the one or more operational parameters and the UDI value corresponding to the rotating asset. In one example, the vibration class of the rotating asset may be identified in correspondence to a pre-defined vibration range for the rotating asset. In one example, the vibration class of the asset may be static values based on International Organization for Standardization (ISO) standards for machinery. In another example, the vibration class of the asset may be identified dynamically.

At block 806, the method includes calculating an aggregated value of UDI, a rate of change in the UDI, and an impact factor for a second period of time where the second period of time is associated with the vibration class of the rotating asset. In one example, the impact factor may be determined in correspondence to at least one of an aggregated value of the UDI, a rate of change in the UDI, and a vibration class of the asset where the aggregated UDI and the rate of change in the UDI is computed for a second period of time. In one example, the second period of time may correspond to a duration for which the UDI values of the asset are to be monitored, and further aggregated to determine the RUL corresponding to the said asset. In one example, the second period of time may be dependent on the vibration class of the asset, where the second period of time may be inversely proportional to the vibration class identified for the rotating asset, i.e., higher the vibration class, lower will be the second time period.

At block 808, the method 800 includes determining a RUL of the rotating asset in correspondence to at least one of the UDI, an average life span of the rotating asset, a current age of the rotating asset, the impact factor, and the vibration class of the rotating asset.

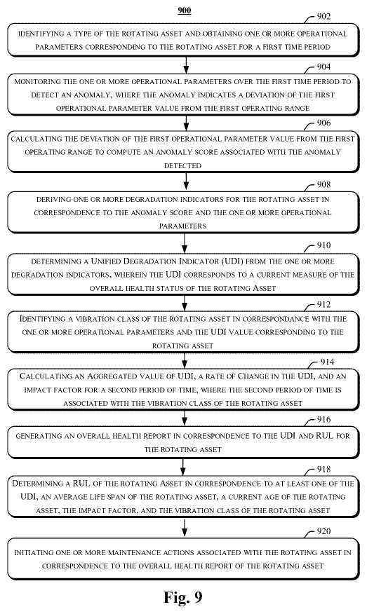

FIG. 9 illustrates another method 900 for determining an overall health status a rotating asset operating in a facility, in accordance with an example implementation of the present subject matter. The order in which the method 900 is described is not intended to be construed as a limitation, and any number of the described method blocks can be combined in any order to implement method 900 or an alternative method. Additionally, individual blocks may be deleted from the method 900 without departing from the spirit and scope of the subject matter described herein. Furthermore, the method 900 may be implemented in any suitable hardware, computer readable instructions, firmware, or combination thereof. For discussion, the method 900 is described with reference to the implementations illustrated in FIGS. 1-6.

At block 902, the method 900 includes identifying a type of the rotating asset and obtaining one or more operational parameters corresponding to the rotating asset for a first time period. In one example, the one or more operational parameters are obtained from one or more sensing elements coupled to the rotating asset.

At block 904, the method 900 includes monitoring the one or more operational parameters over the first time period to detect an anomaly, where the anomaly indicates a deviation of the first operational parameter value from the first operating range. In one example, the one or more operational parameters are monitored over the first time period to determine at least a first operational parameter value from amongst the one or more operational parameters to be beyond a first operating range to detect the anomaly.

At block 906, the method includes 900 calculating the deviation of the first operational parameter value from the first operating range to compute an anomaly score associated with the anomaly detected.

At block 908, the method 900 includes deriving one or more degradation indicators for the rotating asset in correspondence to the anomaly score and the one or more operational parameters, wherein each degradation indicator from the one or more degradation indicators is indicative of an aspect of an overall health status of the rotating asset.

At block 910, the method 900 includes determining a Unified Degradation Indicator (UDI) from the one or more degradation indicators, wherein the UDI corresponds to a current measure of the overall health status of the rotating asset.

At block 912, the method 900 includes identifying a vibration class of the rotating asset in correspondence with the one or more operational parameters and the UDI value corresponding to the rotating asset.

At block 914, the method 900 includes calculating an aggregated value of UDI, a rate of change in the UDI, and an impact factor for a second period of time based, where the second period of time is associated with the vibration class of the rotating asset.

At block 916, the method 900 includes determining a RUL of the rotating asset in correspondence to at least one of the UDI, an average life span of the rotating asset, a current age of the rotating asset, the impact factor, and the vibration class of the rotating asset.

At block 918, the method 900 includes generating an overall health report in correspondence to the UDI and RUL for the rotating asset.

At block 920, the method 900 includes initiating one or more maintenance actions associated with the rotating asset in correspondence to the overall health report of the rotating asset.

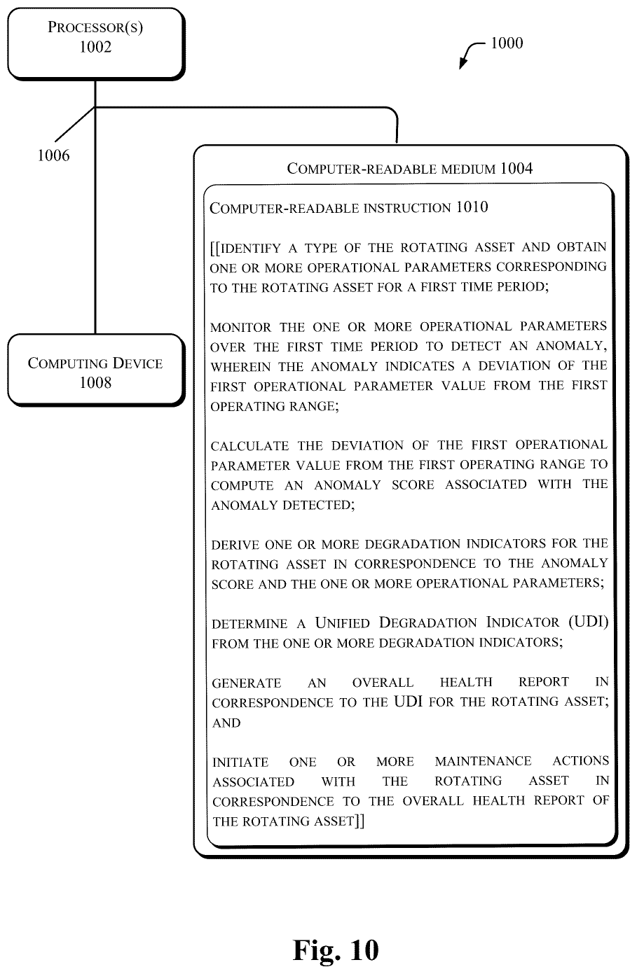

FIG. 10 illustrates a non-transitory computer-readable medium for determining an overall health status of the rotating asset operating in a facility, in accordance with an example of the present subject matter. In an example, the computing environment 1000 includes processor 1002 communicatively coupled to a non-transitory computer readable medium 1004 through communication link 1006. In an example implementation, the computing environment 1000 may be for example, the system for asset monitoring, such as the asset monitoring system 106. In an example, the processor 1002 may have one or more processing resources for fetching and executing computer-readable instructions from the non-transitory computer readable medium 1004. The processor 1002 and the non-transitory computer readable medium 1004 may be implemented, for example, in the system for asset monitoring.

The non-transitory computer readable medium 1004 may be, for example, an internal memory device or an external memory. In an example implementation, the communication link 1006 may be a network communication link, or other communication links, such as a PCI (Peripheral component interconnect) Express, USB-C (Universal Serial Bus Type-C) interfaces, I2C (Inter-Integrated Circuit) interfaces, and the like. In an example implementation, the non-transitory computer readable medium 1004 includes a set of computer readable instructions 1010 which may be accessed by the processor 1002 through the communication link 1006 and subsequently executed for determining an overall health status of the rotating asset. The processor(s) 1002 and the non-transitory computer readable medium 1004 may also be communicatively coupled to a computing device 1008 over the network.

Referring to FIG. 10, in an example, the non-transitory computer readable medium 1004 includes computer readable instructions 1010 that cause the processor 1002 to identify a type of the rotating asset and obtain one or more operational parameters corresponding to the rotating asset for a first time period, where the one or more operational parameters are obtained from one or more sensing elements coupled to the rotating asset.

The instructions 1010 may further cause the processor 1002 to monitor the one or more operational parameters over the first time period to determine at least a first operational parameter value from amongst the one or more operational parameters to be beyond a first operating range to detect an anomaly, where the anomaly indicates a deviation of the first operational parameter value from the first operating range.

The instructions 1010 may further cause the processor 1002 to calculate the deviation of the first operational parameter value from the first operating range to compute an anomaly score associated with the anomaly detected and derive one or more degradation indicators for the rotating asset in correspondence to the anomaly score and the one or more operational parameters, where each degradation indicator from the one or more degradation indicators is indicative of an aspect of an overall health status of the rotating asset. Further, instructions 1010 may further cause the processor 1002 to determine a Unified Degradation Indicator (UDI) from the one or more degradation indicators, where the UDI corresponds to a current measure of the overall health status of the rotating asset, generate an overall health report in correspondence to the UDI for the rotating asset, and initiate one or more maintenance actions associated with the rotating asset in correspondence to the overall health report of the rotating asset. In one example, instructions 1010 may further cause the processor 1002 to determine a remaining useful life of the rotating asset in correspondence to at least one of the UDI, an average life span of the rotating asset, a current age of the rotating asset, an impact factor, and a vibration class of the rotating asset.

Although examples of the present subject matter have been described in language specific to methods and/or structural features, it is to be understood that the present subject matter is not limited to the specific methods or features described. Rather, the methods and specific features are disclosed and explained as examples of the present subject matter.

I/We claim:

1. A method to determine an overall health status of a rotating asset operating in a facility, the method comprising:
identifying a type of the rotating asset and obtaining one or more operational parameters corresponding to the rotating asset for a first time period, wherein the one or more operational parameters are obtained from one or more sensing elements coupled to the rotating asset;
monitoring the one or more operational parameters over the first time period to determine at least a first operational parameter value from amongst the one or more operational parameters to be beyond a first operating range to detect an anomaly, wherein the anomaly indicates a deviation of the first operational parameter value from the first operating range;
calculating the deviation of the first operational parameter value from the first operating range to compute an anomaly score associated with the anomaly detected;
deriving one or more degradation indicators for the rotating asset in correspondence to the anomaly score and the one or more operational parameters, wherein each degradation indicator from the one or more degradation indicators is indicative of an aspect of an overall health status of the rotating asset;
determining a Unified Degradation Indicator (UDI) from the one or more degradation indicators, wherein the UDI corresponds to a current measure of the overall health status of the rotating asset;
generating an overall health report in correspondence to the UDI for the rotating asset; and
initiating one or more maintenance actions associated with the rotating asset in correspondence to the overall health report of the rotating asset.

2. The method as claimed in claim 1 further comprises assigning a priority to the one or more degradation indicators in correspondence to an application in which the rotating asset is being utilized.

3. The method as claimed in claim 1, wherein the one or more operational parameters include vibration, acceleration, and temperature.

4. The method as claimed in claim 1, wherein the one or more degradation indicators are associated with a degradation value which corresponds to an extent of degradation of the corresponding one or more degradation indicators.

5. The method as claimed in claim 1, wherein the UDI is determined dynamically in correspondence to a current operational parameter value amongst the one or more operational parameters and wherein a value of the UDI is in a range of 0 to 1.

6. The method as claimed in claim 1, wherein the one or more degradation indicators include rolling cumulative anomaly count, a rate of change in cumulative anomaly count, rolling mean of anomaly score, rolling standard deviation of anomaly score, rolling kurtosis for vibration axes, and rolling number of starts.

7. The method as claimed in claim 1 further comprises determining a remaining useful life of the rotating asset in correspondence to at least one of the UDI, an average life span of the rotating asset, a current age of the rotating asset, an impact factor, and a vibration class of the rotating asset.

8. The method as claimed in claim 7 comprises identifying the vibration class of the rotating asset in correspondence to a pre-defined vibration threshold range for the rotating asset.

9. The method as claimed in claim 7, wherein the remaining useful life of the rotating asset is determined on identifying the vibration class of the rotating asset.

10. The method as claimed in claim 7 further comprises determining the impact factor in correspondence to at least one of an aggregated value of the UDI, a rate of change in the UDI, and the vibration class of the rotating asset, wherein the aggregated UDI and the rate of change in the UDI is computed for a second period of time.

11. The method as claimed in claim 8 further comprises identifying the second period of time in correspondence to the vibration class of the rotating asset.

12. A system to determine an overall health status of a rotating asset operating in a facility, the system comprising:
an assessment module configured to:
identify a type of the rotating asset and obtain one or more operational parameters corresponding to the rotating asset for a first time period, wherein the one or more operational parameters are obtained from one or more sensing elements coupled to the rotating asset; and
a UDI module configured to:
monitor the one or more operational parameters over the first time period to determine at least a first operational parameter value from amongst the one or more operational parameters to be beyond a first operating range to detect an anomaly, wherein the anomaly indicates a deviation of the first operational parameter value from the first operating range;
calculate the deviation of the first operational parameter value from the first operating range to compute an anomaly score associated with the anomaly detected;
derive one or more degradation indicators for the rotating asset in correspondence to the anomaly score and the one or more operational parameters; wherein each degradation indicator from the one or more degradation indicators is indicative of an aspect of an overall health status of the rotating asset;
determine a Unified Degradation Indicator (UDI) from one or more degradation indicators, wherein the UDI corresponds to a current measure of the overall health status of the rotating asset;
generate an overall health report in correspondence to the UDI for the rotating asset; and
initiate one or more maintenance actions associated with the rotating asset in correspondence to the overall health report of the rotating asset.

13. The system as claimed in claim 11, wherein the UDI module is further configured to assign a priority to the one or more degradation indicators in correspondence to an application in which the rotating asset is being utilized.

14. The system as claimed in claim 11, wherein the one or more degradation indicators are associated with a degradation value which corresponds to an extent of degradation of the corresponding one or more degradation indicators; and
wherein the one or more degradation indicators include rolling cumulative anomaly count, a rate of change in cumulative anomaly count, rolling mean of anomaly score, rolling standard deviation of anomaly score, rolling kurtosis for vibration axes, and rolling number of starts.

15. The system as claimed in claim 11, wherein the UDI module is further configured to determine a remaining useful life of the rotating asset in correspondence to at least one of the UDI, an average life span of the rotating asset, a current age of the rotating asset, an impact factor, and a vibration class of the rotating asset.

16. The system as claimed in claim 18, wherein the UDI module is further configured to determine the impact factor in correspondence to at least one of an aggregated value of the UDI and a rate of change in the UDI, wherein the aggregated UDI and the rate of change in the UDI is computed for a second period of time.

17. The system as claimed in claim 19, wherein the UDI module is further configured to identify the vibration class of the rotating asset in correspondence to a pre-defined vibration range for the rotating asset.

18. The system as claimed in claim 20, wherein
the remaining useful life of the rotating asset is determined on identifying the vibration class of the rotating asset; and
wherein the UDI module is further configured to identify the second period of time in correspondence to the vibration class of the rotating asset.

19. A non-transitory computer-readable medium comprising instructions for determining an overall health status of a rotating asset, the instructions being executable by a processor to:
identify a type of the rotating asset and obtain one or more operational parameters corresponding to the rotating asset for a first time period, wherein the one or more operational parameters are obtained from one or more sensing elements coupled to the rotating asset;
monitor the one or more operational parameters over the first time period to determine at least a first operational parameter value from amongst the one or more operational parameters to be beyond a first operating range to detect an anomaly, wherein the anomaly indicates a deviation of the first operational parameter value from the first operating range;
calculate the deviation of the first operational parameter value from the first operating range to compute an anomaly score associated with the anomaly detected;
derive one or more degradation indicators for the rotating asset in correspondence to the anomaly score and the one or more operational parameters, wherein each degradation indicator from the one or more degradation indicators is indicative of an aspect of an overall health status of the rotating asset;
determine a Unified Degradation Indicator (UDI) from the one or more degradation indicators, wherein the UDI corresponds to a current measure of the overall health status of the rotating asset;
generate an overall health report in correspondence to the UDI for the rotating asset; and
initiate one or more maintenance actions associated with the rotating asset in correspondence to the overall health report of the rotating asset.

20. The non-transitory computer-readable medium as claimed in claim 19, wherein the instructions further cause the processor to determine a remaining useful life of the rotating asset in correspondence to at least one of the UDI, an average life span of the rotating asset, a current age of the rotating asset, an impact factor, and a vibration class of the rotating asset.
